(19) United States
(12) Patent Application Publication
(10) Pub. No.: US 2021/0286211 A1
(43) Pub. Date: Sep. 16, 2021

(54) THIN-FILM TRANSISTOR LIQUID-CRYSTAL DISPLAY

(71) Applicant: TCL China Star Optoelectronics Technology Co., Ltd., Shenzhen (CN)

(72) Inventor: Qingyong ZHU, Shenzhen (CN)

(73) Assignee: TCL China Star Optoelectronics Technology Co., Ltd., Shenzhen (CN)

(21) Appl. No.: 16/623,793

(22) PCT Filed: Dec. 4, 2019
(86) PCT No.: PCT/CN2019/122901

§ 371 Date: Dec. 18, 2019

(30) Foreign Application Priority Data
Nov. 14, 2019 (CN) 201911109731.9

(51) Int. Cl. G02F 1/1333; G02F 1/1337

(52) U.S. Cl. CPC G02F 1/133388; G02F 1/13396; G02F 1/133723

(57) ABSTRACT

The present disclosure provides a thin-film transistor liquid-crystal display comprising a first substrate. The first substrate comprises an active area and a non-active area surrounding the active area. The active area is provided with a thin film transistor. The non-active area is provided with a first common electrode, a transfer pad, and an arc-shaped protrusion. The transfer pad is disposed on a side of the non-active area away from the active area and is disposed on the first common electrode for connecting to a common voltage generating circuit. The arc-shaped protrusion is disposed on a side of the non-active area near the active area. By providing the arc-shaped protrusion, the thin film transistor liquid crystal display prevents abnormal display caused by an alignment solution spreading to the transfer pad in the non-active area of the first substrate when the alignment solution is coated on the active area.

The present application claims priority to Chinese Patent Application No. 201911109731.9, entitled “THIN-FILM TRANSISTOR LIQUID CRYSTAL DISPLAY”, and filed on Nov. 14, 2019, the contents of which are incorporated into the present disclosure.

### FIELD OF INVENTION

The present disclosure relates to the field of thin-film transistor liquid-crystal display (TFT-LCD) technology, and particularly to a thin-film transistor liquid-crystal display.

### BACKGROUND

In a current process of fabricating a thin-film transistor liquid-crystal display, in order to arrange liquid crystals in a same direction between a color filter (CF) substrate and a thin film transistor (TFT) array substrate, an alignment solution is applied on surfaces of the CF substrate and the TFT array substrate facing the liquid crystals and aligned to form alignment films before the CF substrate and the TFT array substrate are cell-assembled. Inkjet printing is a common process for printing alignment solutions and has advantages of high printing efficiency and a high utilization ratio of alignment solution. However, when an alignment solution is printed, the alignment solution freely spreads to form an irregular edge region having uneven thickness. Therefore, it is necessary to expand the irregular edge region as much as possible to reduce an average thickness of the irregular edge region to prevent affecting uniformity of a cell gap.

In general, the irregular edge region needs to be spread to 1.2-2.4 mm from an edge of an active area so as not to affect the uniformity of the cell gap. Therefore, for a narrow frame product having a frame (non-active area) width of less than 2.4 mm, when an alignment solution is printed on an active area of an TFT array substrate, the alignment solution easily spreads to a transfer pad disposed in a non-active area. Since the alignment solution is insulative, when the alignment solution covers the transfer pad, the transfer pad is poorly connected to a conductive particle. Therefore, a signal of the TFT array substrate cannot be transmitted to a common electrode of the CF substrate via the transfer pad and the conductive particle, resulting in display abnormality.

### SUMMARY OF DISCLOSURE

In order to solve the technical problem that the alignment solution easily spreads to the transfer pad, the present disclosure provides a thin-film transistor liquid-crystal display comprising a first substrate. The first substrate comprises an active area and a non-active area surrounding the active area. The active area is provided with a thin film transistor. The non-active area is provided with a first common electrode, a transfer pad, and an arc-shaped protrusion. The transfer pad is disposed on a side of the non-active area away from the active area and is disposed on the first common electrode for connecting to a common voltage generating circuit. The arc-shaped protrusion is disposed on a side of the non-active area near the active area.

In an embodiment, an arc radius of the arc-shaped protrusion is greater than or equal to a width of the transfer pad.

In an embodiment, the non-active area is further provided with a circuit electrically connected to the thin film transistor and the first common electrode.

In an embodiment, the thin film transistor comprises a gate electrode layer, an insulating layer, an active layer, and a source/drain electrode layer. The arc-shaped protrusion is a single-layer structure or a multi-layer structure composed of same materials as one or more layers of the thin film transistor.

In an embodiment, the arc-shaped protrusion is a single-layer structure or a multi-layer structure composed of a metal material, an insulating material, an active material, or a combination thereof.

In an embodiment, the active area further comprises an overcoat layer, a columnar photo spacer, a black matrix, a color filter, or a combination thereof. The arc-shaped protrusion is a single-layer structure or a multi-layer structure composed of same materials as one or more of the overcoat layer, the columnar photo spacer, the black matrix, and the color filter.

In an embodiment, the first substrate further comprises an alignment film covering only the active area and a region from the active area to a side of the arc-shaped protrusion near the active area.

In an embodiment, the thin-film transistor liquid-crystal display further comprises a frame, a second substrate, and a conductive particle. The frame sealant covers a region from a side of the arc-shaped protrusion away from the active area to an outer side of the non-active area. The second substrate comprises a second common electrode and cell-assembled with the first substrate by the frame sealant. The conductive particle is disposed on the transfer pad of the first substrate and electrically connected to the second common electrode.

In an embodiment, the frame sealant is doped with a plurality of first ball spacers to maintain a cell gap.

In an embodiment, the active area is provided with a plurality of second ball spacers that are in contact with the first substrate and the second substrate after the first substrate and the second substrate are cell-assembled to maintain the cell gap.

In the thin-film transistor liquid-crystal display, the arc-shaped protrusion is disposed in the non-active area of the TFT array substrate and on the side of the transfer pad near the active area, that is, in a direction in which the alignment solution spreads to the transfer pad. The arc radius of the arc-shaped protrusion is greater than or equal to the width of the transfer pad. The arc-shaped protrusion is configured to guide the alignment solution to bypass the transfer pad when the alignment solution is applied to the active area of the TFT array substrate, thereby preventing the alignment solution from covering the transfer pad of the non-active area.

Therefore, the thin-film transistor liquid-crystal display can solve the problem that: in a narrow frame product having a frame (non-active area) width of less than 2.4 mm, when an alignment solution is printed on an active area of an TFT array substrate, the alignment solution easily spreads to a transfer pad disposed in a non-active area, resulting in a poor connection between the transfer pad and a conductive particle, and then causing display abnormality. Furthermore, the arc-shaped protrusion can be simultaneously formed with one or more layers of the TFT array substrate without adding a new process.

### BRIEF DESCRIPTION OF DRAWINGS

In order to more clearly illustrate the technical solutions in the embodiments of the present disclosure, a brief description of accompanying drawings used in the description of the embodiments of the present disclosure will be given below. Obviously, the accompanying drawings in the following description are merely some embodiments of the present disclosure. For those skilled in the art, other drawings may be obtained from these accompanying drawings without creative labor.

FIG. 1 is a schematic diagram of a thin-film transistor liquid-crystal display according to an embodiment of the present disclosure.

FIG. 2 is a cross-sectional side view of a thin-film transistor liquid-crystal display according to an embodiment of the present disclosure.

FIG. 3 is a flowchart of a method of fabricating a thin-film transistor liquid-crystal display according to an embodiment of the present disclosure.

### DETAILED DESCRIPTION

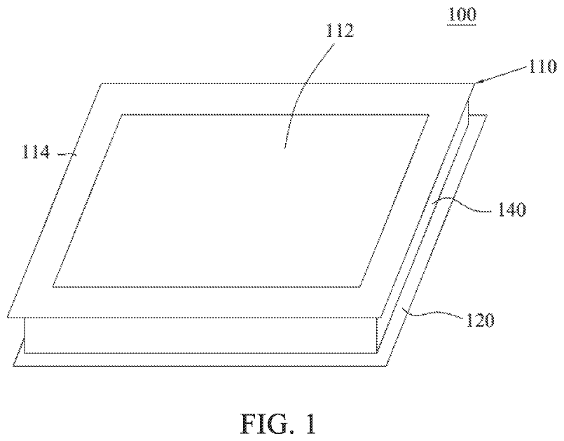

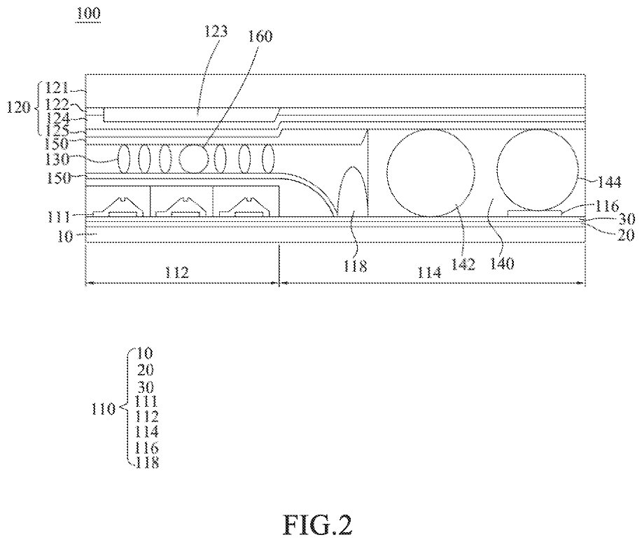

Please refer to FIG. 1 and FIG. 2. The present disclosure provides a thin film transistor liquid crystal display 100 comprising a thin film transistor (TFT) array substrate 110, a color filter (CF) substrate 120, liquid crystals 130, a frame sealant 140, and a conductive particle 144. The TFT array substrate 110 comprises a first glass substrate 10. The first glass substrate 10 is divided into an active area 112 and a non-active area 114 surrounding the active area 112. The active area 112 of the first glass substrate 10 is provided with a plurality of thin film transistors 111. Each thin film transistor 111 comprises a gate electrode layer, an insulating layer, an active layer, and a source/drain layer. The non-active area 114 of the first glass substrate 10 is provided with a driving circuit layer 20, a first common electrode 30, a transfer pad 116, and an arc-shaped protrusion 118. The driving circuit layer 20 is disposed on the first glass substrate 10. The first common electrode 30 is disposed on the driving circuit layer 20. The transfer pad 116 is disposed on the first common electrode 30 for connecting to a common voltage generating circuit. The driving circuit layer 30 comprises a plurality of driving circuits for electrically connecting to the thin film transistors 111 and the first common electrode 30. The common voltage generating circuit is configured to generate a common voltage. The common voltage is transmitted to the driving circuits through the transfer pad 116 and the first common electrode 30, and then the driving circuits generate driving signals to the thin film transistors 111 to control switching of the thin film transistors111. The arc-shaped protrusion 118 is disposed adjacent to a side of the transfer pad 116 near the active area 112 and has an arc radius greater than or equal to a width of the transfer pad 116. A height of the arc-shaped protrusion 118 may be 2-4 μm, and a width of the arc-shaped protrusion 118 may be 5-50 μm, but are not limited thereto, and may be determined according to process accuracy. A process of forming the arc-shaped protrusion 118 may comprise designing arc-shaped protrusion regions on photomasks of one or more layers of the thin-film transistors 111 so that the arc-shaped protrusion 118 has a single-layer structure or a multi-layer structure composed of same materials as one or more layers of the thin film transistor 111. This reduces production costs. In other words, the arc-shaped protrusion 118 may be a single-layer or multi-layer structure composed of a metal material, an insulating material, an active material, or a combination thereof. For example, the arc-shaped protrusion 118 may be a single-layer structure composed of a same material as the gate electrode layer, or a double-layer structure of same materials as the active layer and the source-drain layer.

In one embodiment, the TFT array substrate 110 further comprises an overcoat layer disposed on the active area 112 and covering the thin film transistors 111. A whole or a part of the arc-shaped protrusion 118 is composed of a same material as the overcoat layer.

In one embodiment, the CF substrate 120 comprises a second glass substrate 121, a light-shielding layer (i.e., black matrix (BM)) 122, a color filter layer 123, a protective layer 124, and a second common electrode 125. The light-shielding layer 122 is configured to: (1) shield areas other than the color filter layer 123 to prevent light leakage from a backlight, thereby improving a contrast ratio of the thin-film transistor liquid-crystal display 100; (2) prevent three primary color lights, generated by light from the backlight passing through adjacent red, blue, and green photoresists of the color filter layer 123, from being mixed, thereby improving color purity of the thin-film transistor liquid crystal display 100, and (3) prevent light from causing malfunction of the thin film transistor 111 and changing the operating parameters of the thin film transistors 111. The light-shielding layer 122 may be composed of a black resin, a single-layer of chromium (Cr), or a double-layer of chromium (Cr)/chromium oxide (CrOx). The black resin is a resin doped with an inorganic or organic black pigment. The inorganic black pigment may be carbon black, titanium black, manganese dioxide, or a combination thereof, but is not limited thereto. The color filter layer 123 comprises photoresists of three primary colors of red, blue, and green. The red, blue, and green photoresists may be arranged as in a triangular, square, linear, or mosaic configuration. The protective layer 124 is configured to prevent contaminants on the color filter layer 123 from contacting the liquid crystals and causing malfunction, and to planarize the light-shielding layer 122 and the color filter layer 123 to facilitate further fabrication of the second common electrode 125 thereon. The protective layer 124 may be composed of a polymer material such as an epoxy resin, an acrylic resin, a polyimide resin, and polyvinyl alcohol resin. The second common electrode 125 is a transparent conductive film composed of indium tin oxide.

In an embodiment, the TFT array substrate 110 is a COA (color filter on array) type TFT array substrate. The color filter layer 123 is disposed on the active area 112 of the TFT array substrate 110. A whole or a part of the arc-shaped protrusion 118 is composed of a same material as the color filter layer 123. That is, the whole or a part of the arc-shaped protrusion 118 may be composed of a red, blue or green photoresist.

In an embodiment, the TFT array substrate 110 is a BOA (black matrix on array) type TFT array substrate. The light-shielding layer 122 (i.e., black matrix (BM)) is disposed on the TFT array substrate 110. A whole or a part of the arc-shaped protrusion 118 is composed of a same material as the light-shielding layer 122. That is, the whole or a part of the arc-shaped protrusion 118 may be composed of a black resin, a single-layer of chromium (Cr), or a double-layer of chromium (Cr)/chrome oxide (CrOx).

In one embodiment, the TFT array substrate 110 and the CF substrate 120 are cell-assembled by the frame sealant 140. The frame sealant 140 is coated on a region beside a side of the arc-shaped protrusion 118 in the non-active area 114 of the TFT array substrate 110 away from the active area 112. The frame sealant 140 is doped with a plurality of first ball spacers 142 having a same radius to maintain uniformity of a cell gap. The conductive particle 144 is disposed on the transfer pad 116 of the TFT array substrate 110 and connected to the second common electrode 125 of the CF substrate 120. Therefore, the common voltage generated by the common voltage generating circuit can be transmitted to the second common electrode 125 of the CF substrate 120 through the transfer pad 116 and the conductive particle 144. In other words, a signal of the TFT array substrate 110 can be transmitted to the CF substrate 120 through the transfer pad 116 and the conductive particle 144. The conductive particle 144 may be a microsphere uniformly coated with one or more metal layers on the surface thereof. The metal layers may be composed of gold, silver, copper, tin, or a combination thereof, but is not limited thereto. The microsphere may be composed of silicon dioxide or a polymer such as plastic. The conductive particle is configured to maintain the uniformity of the cell gap.

In an embodiment, the liquid crystals 130 are disposed in the active area 112 of the TFT array substrate 110 and sealed between the CF substrate 120 and the TFT array substrate 110. The liquid crystals 130 may be nematic liquid crystals, smectic liquid crystals, cholesteric liquid crystals, or a combination thereof. The liquid crystals 130 may be doped with an optically active agent. Two alignment films 150 are respectively disposed on surfaces of the TFT array substrate 110 and the CF substrate 120 that face each other. The alignment films 150 are configured to provide a pretilt angle so that alignment directions of the liquid crystals 130 between the CF substrate 120 and the TFT array substrate 110 are consistent. The alignment film 150 may be composed of polyimide.

In an embodiment, in order to prevent a distance (i.e. cell gap) between the TFT array substrate 110 and the CF substrate 120 from being changed due to pressure, a plurality of second ball spacers 160 are scattered on the active area 112 of the TFT array substrate 110. The ball spacers 160 are in contact with the TFT array substrate 110 and the CF substrate 120 so as to maintain the cell gap.

In an embodiment, the TFT array substrate 110 is a POA (photo spacer on array) type TFT array substrate, that is, a plurality of columnar photo spacers (PS) are disposed on the active area of the TFT array substrate 110 to replace the second ball spacers 160. A whole or a part of the arc-shaped protrusion 118 is composed of a same material as the columnar photo spacers.

In an embodiment, the arc-shaped protrusion 118 is a multi-layer structure composed of same materials as one or more layers of the thin film transistor 111, and/or one or more of the overcoat layer, the columnar photo spacers, the black matrix, and the color filter.

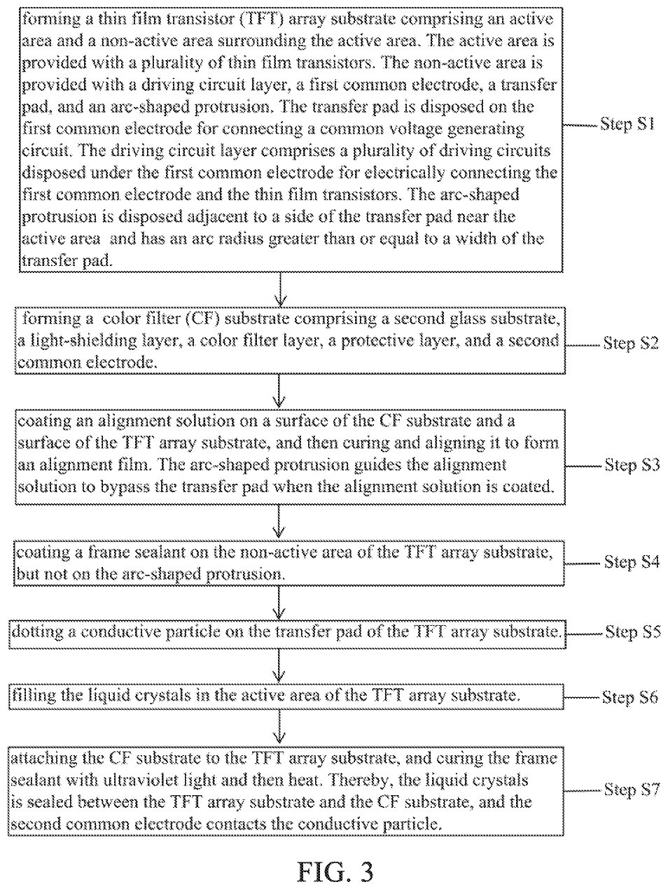

Please refer to FIG. 1-3. FIG. 3 is a flowchart of a method of fabricating a thin-film transistor liquid-crystal display 100 according to an embodiment of the present disclosure. The method of fabricating a thin-film transistor liquid-crystal display 100 comprises the following steps.

Step S1: forming a thin film transistor (TFT) array substrate 110 comprising a first glass substrate 10. The first glass substrate 10 is divided into an active area 112 and a non-active area 114 surrounding the active area 112. The active area 112 of the first glass substrate 10 is provided with a plurality of thin film transistors 111. Each thin film transistor 111 comprises a gate electrode layer, an insulating layer, an active layer, and a source/drain layer. The non-active area 114 of the first glass substrate 10 is provided with a driving circuit layer 20, a first common electrode 30, a transfer pad 116, and an arc-shaped protrusion 118. The driving circuit layer 20 is disposed on the first glass substrate 10. The first common electrode 30 is disposed on the driving circuit layer 20. The transfer pad 116 is disposed on the first common electrode 30 for connecting a common voltage generating circuit. The driving circuit layer 30 comprises a plurality of driving circuits for electrically connecting the thin film transistors 111 and the first common electrode 30. The common voltage generating circuit is configured to generate a common voltage. The common voltage is transmitted to the driving circuits through the transfer pad 116 and the first common electrode 30, and then the driving circuits generate driving signals to the thin film transistors 111 to control switching of the thin film transistors111. The arc-shaped protrusion 118 is disposed adjacent to a side of the transfer pad 116 near the active area 112 and has an arc radius greater than or equal to a width of the transfer pad 116. A height of the arc-shaped protrusion 118 may be 2-4 μm, and a width of the arc-shaped protrusion 118 may be 5-50 μm, but are not limited thereto, and may be determined according to process accuracy. A process of forming the arc-shaped protrusion 118 may comprise designing arc-shaped protrusion regions on photomasks of one or more layers of the thin-film transistors 111 so that the arc-shaped protrusion 118 has a single-layer structure or a multi-layer structure composed of same materials as one or more layers of the thin film transistor 111. This reduces production costs. In other words, the arc-shaped protrusion 118 may be composed of a metal material, an insulating material, an active material, or a combination thereof. For example, in a process of forming the active layers of the thin film transistors 111, an arc-shaped protrusion region is designed on a corresponding photomask, and then a part of the arc-shaped protrusion 118 is formed through exposure and development. Furthermore, in a process of forming the source/drain layers, another arc-shaped protrusion region is designed on a corresponding photomask, and then another part of the arc-shaped protrusion 118 is formed by exposure and development. Thereby, the arc-shaped protrusion 118 has a double-layer structure composed of same materials as the active layer and the source/drain layer. In other words, the arc-shaped protrusion 118 is a double-layer structure composed of a metal material and an active material.

In one embodiment, the TFT array substrate 110 further comprises an overcoat layer disposed on the active area 112 and covering the thin film transistors 111. In a process of forming the overcoat layer on the TFT array substrate 110, an arc-shaped protrusion area is designed on a region of a corresponding photomask. The region corresponds to a side of the transfer pad 116 near the active area 112. Then, a whole or a part of the arc-shaped protrusion 118 composed of a same material as the overcoat layer is formed through exposure and development. Other parts of the arc-shaped protrusion 118 may be a single-layer or multi-layer structure composed of the same materials as one or more layers of the thin-film transistors 111.

Step S2: forming a CF substrate 120 comprising a second glass substrate 121, a light-shielding layer (i.e., black matrix (BM)) 122, a color filter layer 123, a protective layer 124, and a second common electrode 125. The light-shielding layer 122 is configured to: (1) shield areas other than the color filter layer 123 to prevent light leakage from a backlight, thereby improving a contrast ratio of the thin-film transistor liquid-crystal display 100; (2) prevent three primary color lights, generated by light from the backlight passing through adjacent red, blue, and green photoresists of the color filter layer 123, from being mixed, thereby improving color purity of the thin-film transistor liquid crystal display 100, and (3) prevent light from causing malfunction of the thin film transistor 111 and changing the operating parameters of the thin film transistors 111. The light-shielding layer 122 may be composed of a black resin, a single-layer of chromium (Cr), or a double-layer of chromium (Cr)/chromium oxide (CrOx). A light-shielding layer composed of a black resin is formed by coating a resin doped with an inorganic or organic black pigment on a glass substrate, and then patterning the resin to form a matrix pattern by a photolithography and etching process (PEP). The inorganic black pigment may be carbon black, titanium black, manganese dioxide, or a combination thereof, but is not limited thereto. A light-shielding layer having a single-layer of chromium (Cr) or a double-layer of chromium (Cr)/chrome oxide (CrOx) is formed by sputtering chromium (Cr) and/or chromium oxide (CrOx) on a glass substrate and patterning it by PEP. The color filter layer 123 comprises photoresists of three primary colors of red, blue, and green. The red, blue, and green photoresists may be arranged as in a triangular, square, linear, or mosaic configuration. The color filter layer 123 may be made by using a dyeing method, an etching method, a printing method, a dry film method, or an electrocoating method, but is not limited thereto. The protective layer 124 is configured to prevent contaminants on the color filter layer 123 from contacting the liquid crystals and causing malfunction, and to planarize the light-shielding layer 122 and the color filter layer 123 to facilitate further fabrication of the second common electrode 125 thereon. The protective layer 124 may be composed of a polymer material such as an epoxy resin, an acrylic resin, a polyimide resin, and polyvinyl alcohol resin. The second common electrode 125 is a transparent conductive film composed of indium tin oxide. The second common electrode 125 may be formed by sputtering indium tin oxide on the protective layer 124.

In an embodiment, the TFT array substrate 110 is a COA (color filter on array) type TFT array substrate. The color filter layer 123 is disposed on the active area 112 of the TFT array substrate 110. In a process of forming the color filter layer 123 on the TFT array substrate 110, an arc-shaped protrusion area is designed on a region of a corresponding photomask. The region corresponds to a side of the transfer pad 116 near the active area 112. Then, a whole or a part of the arc-shaped protrusion 118 composed of a same material as the color filter layer 123 is formed through exposure and development. That is, the whole or a part of the arc-shaped protrusion 118 may be composed of a red, blue or green photoresist.

In an embodiment, the TFT array substrate 110 is a BOA (black matrix on array) type TFT array substrate. The light-shielding layer122 (i.e., black matrix (BM)) is disposed on the TFT array substrate 110. In a process of forming the light-shielding layer122 on the TFT array substrate 110, an arc-shaped protrusion area is designed on a region of a corresponding photomask. The region corresponds to a side of the transfer pad 116 near the active area 112. Then, a whole or a part of the arc-shaped protrusion 118 composed of a same material as the light-shielding layer122 is formed through exposure and development. That is, the whole or a part of the arc-shaped protrusion 118 may be composed of a black resin, a single-layer of chromium (Cr), or a double-layer of chromium (Cr)/chrome oxide (CrOx).

Step S3: coating an alignment solution on a surface of the CF substrate 120 and a surface of the TFT array substrate 110, and then curing and aligning it to form an alignment film 150. The arc-shaped protrusion 118 guides the alignment solution to bypass the transfer pad 116 when the alignment solution is coated. The alignment films 150 are configured to provide a pretilt angle so that alignment directions of the liquid crystals 130 between the CF substrate 120 and the TFT array substrate 110 are consistent. The alignment solution may comprise polyamic acid, polyimide (PI), polyimide-polyamic acid copolymer, or a combination thereof, and an organic solvent such as N, N-dimethylacetamide (DMA) and N-Methyl-2-pyrrolidone (NMP). The alignment solution may be coated by inkjet printing. After the alignment solution is coated, the organic solvent is first volatilized by pre-bake, and then polyamic acid, polyimide, and/or polyimide-polyamic acid copolymer are polymerized to form the alignment film 150 by post-bake. The alignment films 150 may be aligned by directional friction, that is, rubbing the alignment film 150 by a roller coated with a fluff cloth such as cotton, nylon, or polyester.

Step S4: coating a frame sealant 140 on the non-active area 114 of the TFT array substrate 110, but not on the arc-shaped protrusion 118. The frame sealant 140 is doped with a plurality of first ball spacers 142 having a same radius to maintain uniformity of a cell gap.

Step S5: dotting a conductive particle 144 on the transfer pad 116 of the TFT array substrate 110. The conductive particle 144 may be a microsphere uniformly coated with one or more metal layers on the surface thereof. The metal layers may be composed of gold, silver, copper, tin, or a combination thereof, but is not limited thereto. The microsphere may be composed of silicon dioxide or a polymer such as plastic. The conductive particle is configured to maintain the uniformity of the cell gap.

Step S6: filling the liquid crystals 130 in the active area 112 of the TFT array substrate 110. The liquid crystals 130 may be nematic liquid crystals, smectic liquid crystals, cholesteric liquid crystals, or a combination thereof. The liquid crystals 130 may be doped with an optically active agent. The filling is performed by using one drop filling (ODF) to drop the liquid crystals 130 on the active area 112 of the TFT array substrate 110.

Step S7: attaching the CF substrate 120 to the TFT array substrate 110, and curing the frame sealant 140 with ultraviolet light and then heat. Thereby, the liquid crystals 130 is sealed between the TFT array substrate 110 and the CF substrate 120, and the second common electrode 125 contacts the conductive particle 144. The common voltage generated by the common voltage generating circuit can be transmitted to the second common electrode 125 of the CF substrate 120 through the transfer pad 116 and the conductive particle 144. In other words, a signal of the TFT array substrate 110 can be transmitted to the CF substrate 120 through the transfer pad 116 and the conductive particle 144.

In an embodiment, in order to prevent a distance (i.e. cell gap) between the TFT array substrate 110 and the CF substrate 120 from being changed due to pressure, a plurality of second ball spacers 160 are scattered on the active area 112 of the TFT array substrate 110 before the filling the liquid crystals 130 in Step S6. After the TFT array substrate 110 and the CF substrate 120 are cell-assembled, the ball spacers 160 are in contact with the TFT array substrate 110 and the CF substrate 120 so as to maintain the cell gap.

In an embodiment, the TFT array substrate 110 is a POA (photo spacer on array) type TFT array substrate, that is, a plurality of columnar photo spacers (PS) are disposed on the active area of the TFT array substrate 110 to replace the second ball spacers 160. In a process of forming the columnar photo spacers on the TFT array substrate 110, an arc-shaped protrusion area is designed on a region of a corresponding photomask. The region corresponds to a side of the transfer pad 116 near the active area 112. Then, a whole or a part of the arc-shaped protrusion 118 composed of a same material as the columnar photo spacers is formed through exposure and development.

In an embodiment, the arc-shaped protrusion 118 is a multi-layer structure composed of same materials as one or more layers of the thin film transistor 111, and/or one or more of the overcoat layer, the columnar photo spacers, the black matrix, and the color filter.

In the above, in the thin-film transistor liquid-crystal display and the method of fabricating the same, based on that the alignment solution, such as polyimide, has a surface tension which will make it bypass a circular via hole on a TFT when it spreads on a TFT array substrate, the arc-shaped protrusion is disposed in the non-active area of the TFT array substrate and on the side of the transfer pad near the active area, that is, in a direction in which the alignment solution spreads to the transfer pad. The arc radius of the arc-shaped protrusion is greater than or equal to the width of the transfer pad. The arc-shaped protrusion is configured to guide the alignment solution to bypass the transfer pad when the alignment solution is applied to the active area of the TFT array substrate, thereby preventing the alignment solution from covering the transfer pad of the non-active area. Therefore, the thin-film transistor liquid-crystal display can solve the problem that in a narrow frame product having a frame (non-active area) width less than 2.4 mm, when an alignment solution is printed on an active area of an TFT array substrate, the alignment solution easily spreads to a transfer pad disposed in a non-active area, resulting in a poor connection between the transfer pad and a conductive particle, and then causing display abnormality. Furthermore, the arc-shaped protrusion can be simultaneously formed with one or more layers of the TFT array substrate without adding a new process.

The present application has been described in the above preferred embodiments, but the preferred embodiments are not intended to limit the scope of the present application, and those skilled in the art may make various modifications without departing from the scope of the present application. The scope of the present application is determined by claims.

What is claimed is:

1. A thin-film transistor liquid-crystal display, comprising:
a first substrate comprising an active area and a non-active area surrounding the active area;
wherein the active area is provided with a thin film transistor, and the non-active area is provided with a first common electrode, a transfer pad, and an arc-shaped protrusion; and
wherein the transfer pad is disposed on a side of the non-active area away from the active area, and is disposed on the first common electrode for connecting to a common voltage generating circuit, and the arc-shaped protrusion is disposed on a side of the non-active area near the active area.

2. The thin-film transistor liquid-crystal display according to claim 1, wherein an arc radius of the arc-shaped protrusion is greater than or equal to a width of the transfer pad.

3. The thin-film transistor liquid-crystal display according to claim 1, wherein the non-active area is further provided with a circuit electrically connected to the thin film transistor and the first common electrode.

4. The thin-film transistor liquid-crystal display according to claim 1, wherein the thin film transistor comprises a gate electrode layer, an insulating layer, an active layer, and a source/drain electrode layer, and the arc-shaped protrusion is a single-layer structure or a multi-layer structure composed of same materials as one or more layers of the thin film transistor.

5. The thin-film transistor liquid-crystal display according to claim 1, wherein the arc-shaped protrusion is a single-layer structure or a multi-layer structure composed of a metal material, an insulating material, an active material, or a combination thereof.

6. The thin-film transistor liquid-crystal display according to claim 1, wherein the active area further comprises an overcoat layer, a columnar photo spacer, a black matrix, a color filter, or a combination thereof, and the arc-shaped protrusion is a single-layer structure or a multi-layer structure composed of same materials as one or more of the overcoat layer, the columnar photo spacer, the black matrix, and the color filter.

7. The thin-film transistor liquid-crystal display according to claim 1, wherein the first substrate further comprises an alignment film covering only the active area and a region from the active area to a side of the arc-shaped protrusion near the active area.

8. The thin-film transistor liquid-crystal display according to claim 1, further comprising:
a frame sealant covering a region from a side of the arc-shaped protrusion away from the active area to an outer side of the non-active area;
a second substrate comprising a second common electrode and cell-assembled with the first substrate by the frame sealant; and
a conductive particle disposed on the transfer pad of the first substrate and electrically connected to the second common electrode.

9. The thin-film transistor liquid-crystal display according to claim 8, wherein the frame sealant is doped with a plurality of first ball spacers to maintain a cell gap.

10. The thin-film transistor liquid-crystal display according to claim 8, wherein the active area is provided with a plurality of second ball spacers that are in contact with the first substrate and the second substrate after the first substrate and the second substrate are cell-assembled to maintain the cell gap.
